(19) United States
(12) Patent Application Publication
(10) Pub. No.: US 2026/0222224 A1
(43) Pub. Date: Jul. 30, 2026

(54) SYSTEM AND METHOD FOR UTILIZING TRUSTED HTML CONTENT

(71) Applicant: Signix, Inc., Chattanooga, TN (US)

(72) Inventor: John Harris, Chattanooga, TN (US)

(21) Appl. No.: 19/144,344

(22) PCT Filed: Oct. 9, 2024
(86) PCT No.: PCT/US2024/050602

§ 371 Date: Jun. 27, 2025

Related U.S. Application Data
(60) Provisional application No. 63/543,390, filed on Oct. 10, 2023.

(51) Int. Cl. H04L 9/32

(52) U.S. Cl. CPC H04L 9/3247

(57) ABSTRACT

Systems and methods are described herein for providing secure and trusted HTML content and for utilizing said trusted HTML content.

### RELATED APPLICATIONS

This application claims priority to U.S. Application No. 63/543,390, filed Oct. 10, 2023.

### TECHNICAL FIELD

This application relates in general to a system and method for providing secure and trusted web data, and more specifically, to a system and method for utilizing trusted HTML content.

### BACKGROUND

Secure exchange of documents in which parties are to exchange, review, accept, and sign the documents to complete a transaction in which contents of a document need to be from a trusted source, need to be identical when viewed by all parties, and changes made to the content, including the addition of a signature, need to be captured such that all parties may trust the identity of the parties and may trust the content and changes made by the identified parties are captured accurately. Currently, this trusted exchange and alteration of documents that are shared with multiple parties over the internet uses various technologies and file formats to provide a level of trust between the parties when the documents are viewed on different computing devices using copies of a document. These technologies and file formats, for example, may utilize data stored in an international standard format, ISO-32000-1, also known as Portable Document Format (PDF), or similar formats that include mechanisms to limit the alteration of contents of files except under controlled and defined mechanisms. None of these technologies and file formats are native to the sharing of data over the internet that typically utilizes Hypertext Markup Language (HTML) and is readily exchanged and viewed using ordinary web browser applications. This limitation of sharing data over the internet is especially problematic for users that utilize mobile devices rather than personal computers or laptops.

Additionally, use of HTML documents to exchange trusted data may experience one or more data attacks including a “man-in-the-middle” in which a perpetrator positions himself in a conversation between a user and an application either to eavesdrop or to impersonate one of the parties, and/or to substitute different content data while making it appear as if a normal exchange of information is underway, and in which one or more parties claim after the fact that the HTML content received differs from a version viewed at a later date. As such, users may not be able to share documents over the internet in a trusted manner using all available devices.

Therefore, a need exists for a system and method for utilizing trusted HTML content. The present invention attempts to address the limitations and deficiencies in prior solutions.

### BRIEF DESCRIPTION OF THE DRAWINGS

Referring now to the drawings in which like reference numbers represent corresponding parts throughout:

FIG. 1 illustrates example embodiments of a system for utilizing trusted HTML content according to the present invention.

FIG. 2 illustrates an embodiment of creation of a published trusted HTML document by a system for utilizing trusted HTML content according to the present invention.

FIG. 3 illustrates an embodiment of creation of a signed trusted HTML document by a system for utilizing trusted HTML content according to the present invention.

FIG. 4 illustrates components of a digital envelope that is part of a trusted HTML document utilized by a system for utilizing trusted HTML content according to the present invention.

FIG. 5 illustrates an example embodiment of a user identification and verification system for utilizing trusted HTML content according to the present invention.

FIG. 6 illustrates a multi-factor authentication code window used to verify an identity of an individual within a system for utilizing trusted HTML content according to the present invention.

FIG. 7 illustrates a mobile device presenting a trusted HTML document in a system for utilizing trusted HTML content according to the present invention.

FIG. 8 illustrates a document signature input window in a system for utilizing trusted HTML content according to the present invention.

FIG. 9 illustrates a trusted document having an embedded signature used within a system for utilizing trusted HTML content according to the present invention.

FIG. 10 illustrates a generalized schematic of a programmable processing system utilized as the various computing components described herein used to implement an embodiment of the present invention.

FIG. 11 illustrates a flowchart corresponding to a method performed by software components of a system for utilizing trusted HTML content according to the present invention.

FIG. 12 illustrates another flowchart corresponding to a method performed by software components of a system for utilizing trusted HTML content according to the present invention.

FIG. 13 illustrates yet another flowchart corresponding to a method performed by software components of a system for signing trusted HTML content according to the present invention.

FIG. 14 illustrates an additional flowchart corresponding to a method performed by software components in a system for verifying trusted HTML content according to the present invention.

FIG. 15 illustrates a certificate of trust for a trusted document publishing request and completion dataset in a system and method for utilizing trusted HTML content according to the present invention.

FIG. 16 illustrates an example certificate of completion for a transaction of a system and method for utilizing trusted HTML content according to the present invention.

FIG. 17 illustrates an example certificate of a trusted document update in a system and method for utilizing trusted HTML content according to the present invention.

FIG. 18 illustrates a computing system of software components for a system and method for utilizing trusted HTML content according to the present invention.

### DETAILED DESCRIPTION

This application relates in general to a system and method for providing secure and trusted web data, and more specifically, to a system and method for utilizing trusted HTML content according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps, or components, but do not preclude the presence or addition of one or more other features, steps, or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “individual” and “user” refer to an entity, e.g., a human, using a system and method for utilizing trusted HTML content according to the present invention. The term user herein refers to one or more users.

The term “trusted document server” refers to a networked or web server that provides processing to determine, verify, and enable trusted HTML content in a document. In various embodiments, the trusted document server may be a dedicated server or any networked processing server, including a publishing server, that provides a service that processes HTML content as otherwise disclosed herein.

The term “publishing server” refers to a networked or web server that publishes trusted HTML content in a document. In various embodiments, the publishing server may be a dedicated server or any networked processing server that provides a service that processes, publishes, and provides HTML content as otherwise disclosed herein.

The term “trusted HTML content” refers to data using Hypertext Markup Language (HTML) within a digital file processed to be trusted data according to the present language. The trusted HTML content is a portion of a web page used to display the content to a user including images, links, form data, and similar components of a web page. The web page containing this content is used when generating a hash value as part of a signature.

The term “hash value” refers to a numeric value of a fixed length that uniquely identifies data. Hash values represent large amounts of data as much smaller numeric values, so they are used with digital signatures.

The term “URL” refers to a Uniform Resource Locator which is a unique identifier used to locate a web resource that specifies its location on a computer network or the Internet and provide a mechanism for retrieving it. A URL is also referred to as a web address. URLs consist of multiple parts, including a protocol and domain name.

The term “digital certificate” refers to an electronic file that is tied to a cryptographic key pair and authenticates the identity of a website, organization, user, device, or server. It is also known as a public key certificate or identity certificate.

The term “digital signature” refers to an electronic, encrypted stamp of authentication on digital information such as email messages, macros, or electronic documents. A signature confirms that the information originated from the signer and has not been altered.

The term “digital envelope” or digital wrapper, refers to a secure digital data container that protects an electronic message through data authentication and encryption. Nested digital envelopes are stored within each other.

The term “mobile device” refers to a small handheld device that has a display screen with touch input and/or a QWERTY keyboard and may provide users with telephony capabilities. These devices include smartphones, tablets, smartwatches, e-readers, and handheld gaming consoles.

The term “web browser” refers to a software application receiving content from a server addressed using a URL to be rendered onto a display device for viewing by a user. The content is specified in HTML.

The term “mobile application” refers to a software application, or app, developed specifically for use on small wireless computing devices such as smartphones and tablets, rather than desktops or laptop computers.

The term “database” refers to an organized collection of structured information, or data, stored and accessed electronically in a computer system. A database is usually controlled by a database management system (DBMS).

The term universally unique identifier (UUID) refers to a 128-bit label, or 36-character alphanumeric string, used to identify information in computer systems. The term globally unique identifier (GUID) is also used.

The term “API” refers to an application programming interface that includes a set of functions and procedures allowing the creation of applications that access the features or data of an operating system, application, or other service.

So that the manner in which the present application can be better understood, certain illustrations and figures are appended hereto. It is to be noted, however, that the drawings illustrate only selected embodiments and elements of the systems and methods described herein and are therefore not to be considered limiting in scope for the systems and methods as described herein may admit to other equally effective embodiments and applications.

All of the documents 101 define their contents using data formatted into HTML. Use of HTML permits the contents of the documents to be rendered for viewing within a web browser using any remote computing device having a web browser. In addition, documents defined using HTML are rendered for viewing on different computing devices to match the rendering of data and best utilize the specific screen size and characteristics of each individual computing device. This capability provides users with improved viewing of the contents of documents used with a particular computing device.

System 100 includes a publishing server 108 and a trusted document server 107 connected to the internet 110 permitting user computing devices 102-105 to communicate with these servers 107-108 as needed. The publishing server 108 receives a document 101 containing HTML content from parties requesting a document be treated as a trusted document. The publishing server 108 stores HTML content in a document database 106a, authenticates the source of the document 101, and requests the trusted document server 107 process the document 101 to capture the contents of the document at a metadata level thereby creating the trusted document as disclosed herein. The trusted document server 107 stores the metadata and hash value into a trusted document database 106b. The published and trusted documents may be retrieved from the publishing server 108 for use by parties as needed.

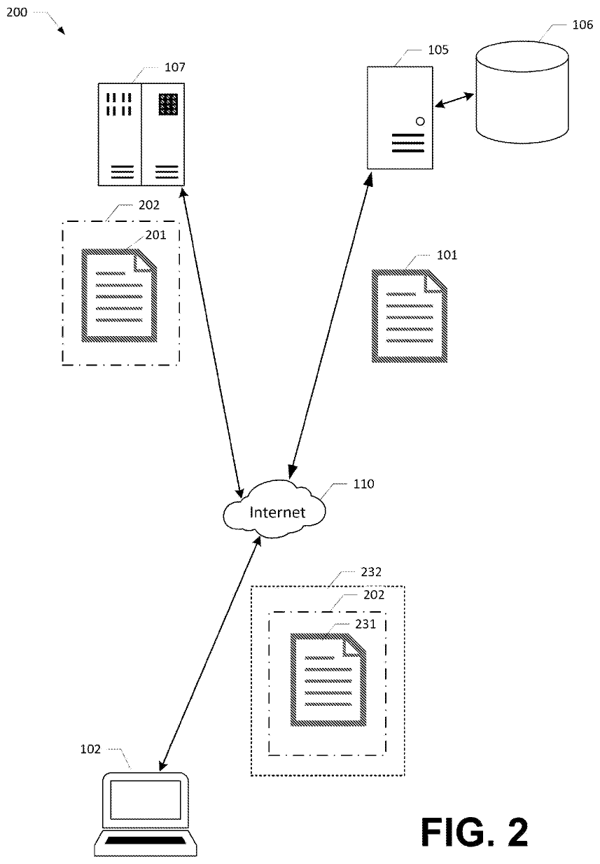

The trusted document server 107 receives an HTML document 101 and encases the content within the document into a digital envelope 202 as disclosed in reference to FIG. 2. The trusted document server 107 authenticates the source of the document being processed to ensure the correct entity is captured and stored in the metadata of the digital envelope. The trusted document server 107 creates the digital envelope 202 within which the hash value generated by the trusted document server 107 is stored. The document in the digital envelope 202 is returned to its source for use as needed.

A HTML document 101 is first uploaded to a publishing server 108 and stored into the document database 106a in order for users 102-105 to obtain the trusted document 201 in a form containing the content intended when the HTML document 101 was uploaded. The publishing server 108 transmits the HTML document 101 to the trusted document server 107 for certification. The trusted document server 107 is used to verify the contents of the HTML document 101 and to sign the hash value of the document indicating that the trusted document 201 has been successfully verified by the trusted document server 107.

The system 100 may utilize any method of authentication of the identities of users as part of the creation and processing of trusted HTML documents as disclosed herein. FIGS. 2-4 below disclose a preferred embodiment for the processing of the HTML document, the authentication of users, and the creation and use of the digital envelope 202. The present invention is not intended to be limited with regards to any of these processes except and recited within limitations of the attached claims. Additionally, the present invention discloses the creation of trusted documents containing HTML content. One skilled in the art will recognize data specified in alternate formats also may be treated as a trusted document as otherwise disclosed herein. Once again, the present invention is not intended to be limited except as recited within the limitations of the attached claims.

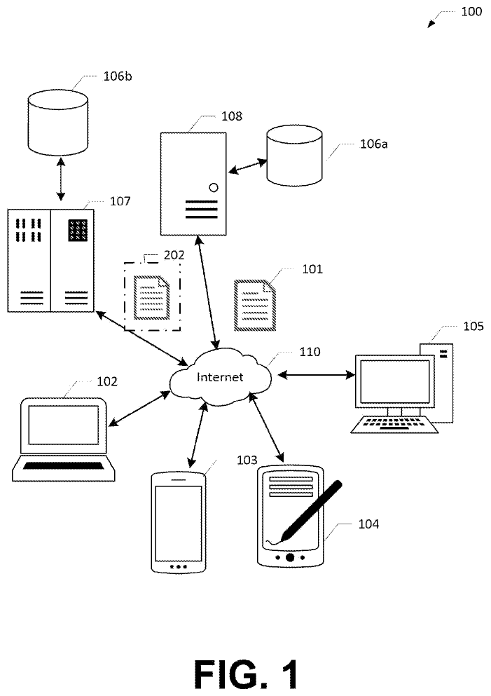

In general, the present disclosure relates to a system and method for utilizing trusted HTML content according to the present invention. FIG. 1 illustrates example embodiments of a system for utilizing trusted HTML content according to the present invention. The system 100 enables users 102-105 to obtain trusted HTML documents 101 in which the contents contained therein correspond to a verified and trusted version of the document using common web browsers. The system 100 also enables users 102-105 to alter the contents of the documents 101 in which the alterations may be trusted by other users 102-105 receiving a copy of the altered document that the alterations made to the document are from a known and authorized user and that the alterations correspond to the changes made by that authorized user.

For example, a document containing a proposed purchase agreement from a seller to a buyer may be edited to change an interest rate and/or the terms of the agreement while all remaining parts of the agreement are rendered to visually appear identical. This editing may be performed by either party to the agreement with the other party to the agreement being unaware of the change. For this reason, among others, HTML previously has not been used in these applications.

The signed trusted document 201, shown in FIG. 2, is returned to the publishing server 108 for use in providing the trusted document 101 to users 102-105 upon request. Recipients of the trusted document 101 may communicate with the trusted document server 107 as needed to verify that a received document contains the complete and accurate copy of the contents of the originally published document when previously verified. Additionally, HTML documents have typically been treated as untrusted documents in that the HTML-formatted data is readily available for inspection within standard web browsers. Users historically have been able to access the HTML and edit its contents to change significant data items in the document that may visually appear to be the same as the original document except for changes made to specific data items.

FIG. 2 illustrates an embodiment of creation of a published trusted HTML document by a system for utilizing trusted HTML content according to the present invention. The system 200 is shown with an HTML document 101 being published by the publishing server 108 and a trusted document 201, which includes the content of the HTML document 101 and the digital envelope 202 that is created and added to the HTML document 101 by the trusted document server 107.

Under an embodiment, both the buyer and seller are expected to alter the document at least to add a signature used to create a binding agreement between the parties. By using the trusted document server 107, as disclosed herein, the parties to the agreement may alter the document with the addition of a signature while having the HTML document 101 remain trusted. In one embodiment, the trusted document server 107 authenticates the parties making edits to the document (adding a signature) as well as adds metadata that provides an auditable trail of all changes made to the document from when first published by the publishing server 108. Signed metadata generated within the trusted document server 107 is maintained in the trusted document database 106b. The addition of a signature or other modification to trusted document 201 creates a new version of the trusted document 201 that may be stored in the document database 106a on the publishing server 108. The document server 108 maintains these different versions of the HTML document 101 in local databases 106a permitting users to retrieve and view any published document with and without any modifications. This process may repeat with the creation of additional versions stored in the document database 106a for each modification and signature added to a document.

The parties may at any time verify that the contents of a document contain only changes accounted for by the auditable trail of changes to provide assurance that the document 101 remains a trusted HTML document. This verification may be performed by a party sending a query to the trusted document server 107 using an API provided by the trusted document server. This query may be generated using utility functions within a user application and/or within web browser components installed into the user's web browser that provide access to the trusted document server 107.

In an alternate embodiment, a party to a transaction specified within an agreement in the above example, such as a bank or lender, may operate the publishing server 108 hosted on the party's web server, hosted on a third-party cloud server, or hosted on a web platform of the trusted document server 107 as a service for its customers. In this alternate embodiment, the bank or lender may authenticate a customer as part of the customer accessing accounts provided by the bank or lender to the customer. Once the authentication operation has been performed to the satisfaction of the parties, the customer may receive a trusted HTML document 101 from the bank's web server. The bank web server (not shown) may submit the HTML document 101 to the trusted document server 107 on behalf of the customer. The submission by the bank web server may indicate that the customer has been authenticated for purposes of processing the trusted document 201 when a signature is added.

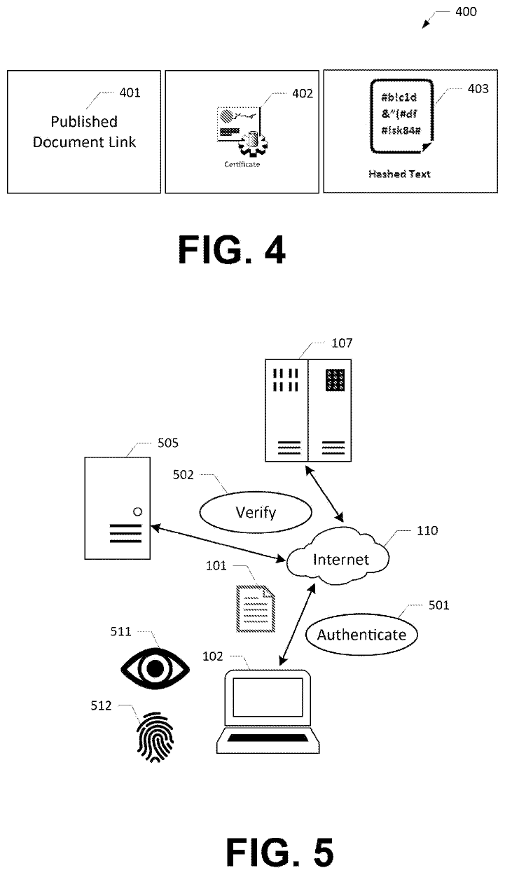

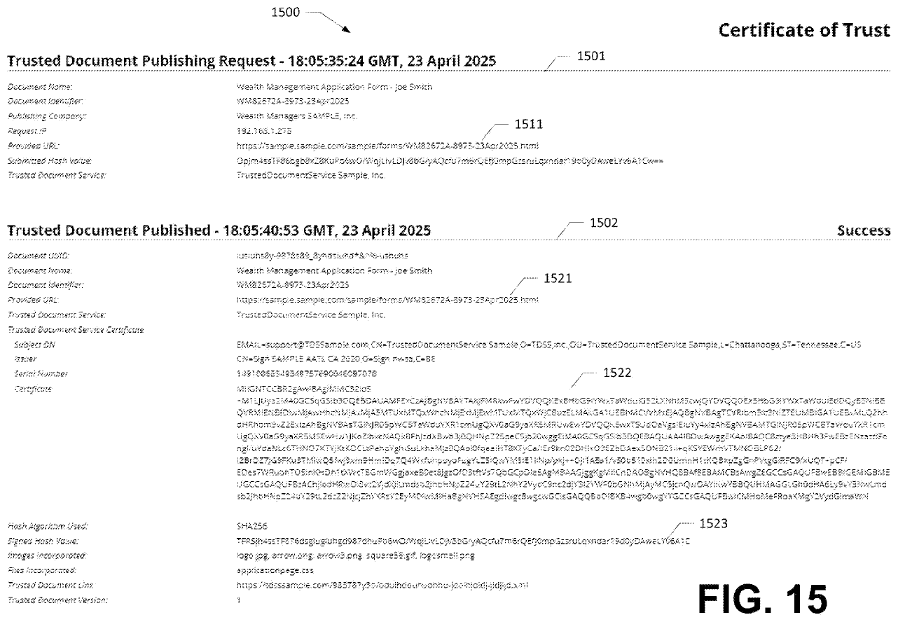

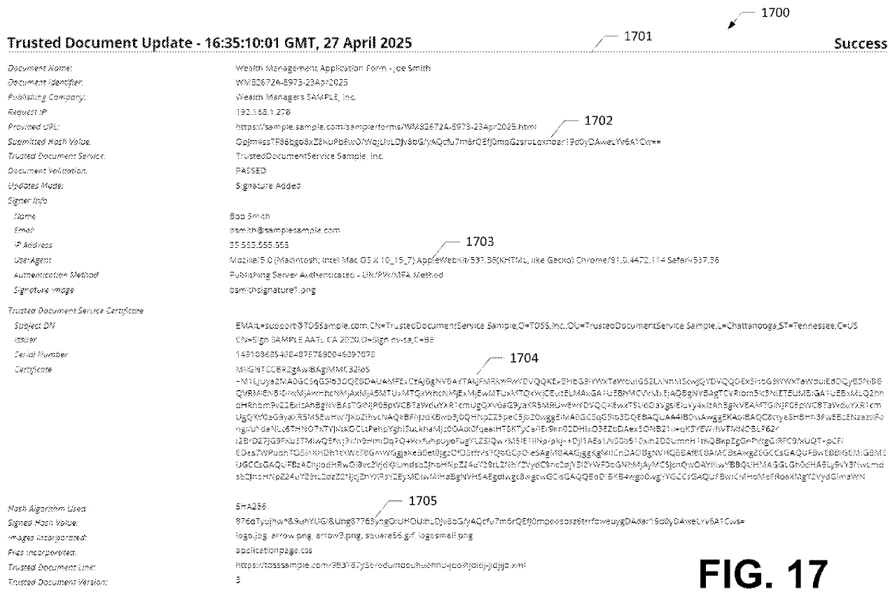

The audit trail is found in the metadata associated with the digital envelope 202 that is generated by the trusted document server 107. Components of the digital envelope 202 are disclosed below in reference to FIG. 4 and may be created from metadata stored in the trusted document database 106b. Parties may validate the contents of a trusted document 201 using the contents of the HTML document 101 and the metadata from the digital envelope 202 to verify that the HTML content generates the data of the digital envelope 202 that matches the values stored within the metadata of the trusted document 201. Any party may independently generate the data values when needed. Alternatively, any party may submit a copy of the trusted document 201 to the trusted document server 107 to generate the data values and validate the copy of the trusted document 201. A detailed example of publishing request data record 1500 is disclosed in FIG. 15 and a further example of a certificate of trust 1700, as shown in FIG. 17, indicating that the parties have signed the document in which the identity of the parties has been verified and the contents of the trusted HTML document 101 has not been altered with the exception of the insertions of one or more signatures as otherwise disclosed herein. This verification process verifies each hash value corresponding to the original document, and one or more versions of the document in which each signature has been added match the original hash values.

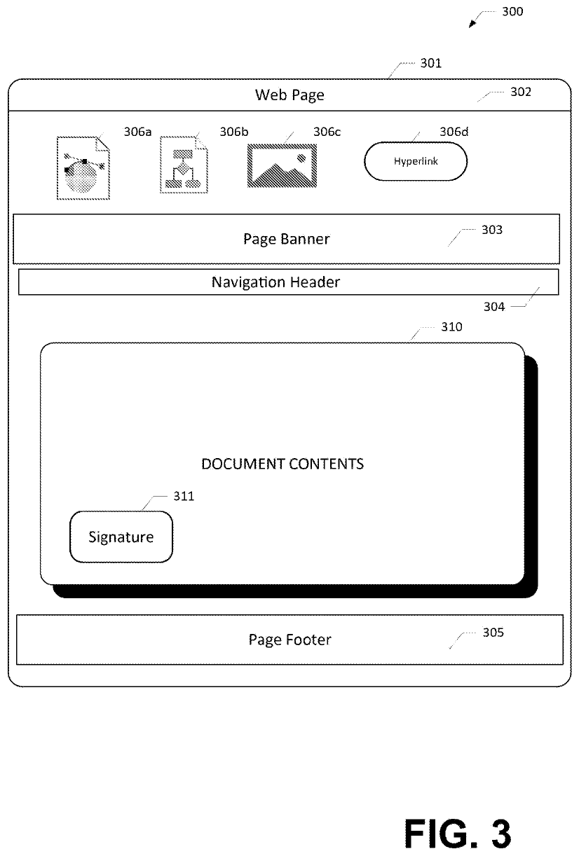

In the above example of FIG. 1, the trusted document 201 is sent to a party to the agreement for the purposes of adding a signature accepting the terms stated within the HTML document 101. When the user 102 adds his/her digital signature, the edited HTML document 231 is sent to the trusted document server 107 to place the edited document within a new digital envelope 232. The edited document 231 may be displayed to a user as a web page 301, as shown in FIG. 3, enabling the user to review and edit the document.

The metadata added to the HTML document 101 to create the trusted document 201 is included within the data being placed within the new digital envelope 232. The changes to the HTML content are also described in the data stored in the new digital envelope 232. From this data stored in the metadata of the new digital envelope 232, the original HTML content of the HTML document 101, and the digital envelope 202, and the new digital envelope 232 may be generated and used to validate the edited HTML document 231.

The above editing and updating process may be repeated additional times when additional parties sign the document or otherwise edit the HTML content. All of the versions of the HTML document 101 may be maintained in the document database 106a with any corresponding metadata stored in the trusted document database 106b. In a preferred embodiment, the trusted document server 107 may be accessed by user computing devices 102-105 using an API to the service running on the trusted document server 107. The user 102, for example, may access the trusted document server 107 using a web browser running on the computing device 102. The web browser may utilize the API of the trusted document server 107 using a browser extension added to the web browser or may be incorporated within the functionality of a web browser supporting the functions disclosed herein.

FIG. 3 illustrates an embodiment of creation of a signed trusted HTML document by a system for utilizing trusted HTML content according to the present invention. In the above example embodiment, the trusted HTML document 101 is presented to a user as a web page 301 having multiple components including a title bar 302, a page banner 303, a navigation header 304, a content window 310, a signature button 311, a page footer 305, and one or more web page elements 306a-d. The web page elements may include graphic image 306a, a diagram 306b, a bitmap or digital image 306c, a hyperlink or button 306d, and similar known elements.

A web page 300 may present one or more of the above components that are defined within the HTML code used to specify the web page 300. These components, and web page elements, may be embedded into the HTML code, or may be obtained separately when the component and element is specified within the HTML code using a separate URL. A web browser will parse the HTML code to obtain the web page components, the components sizes and positions, and similar specified parameters, to render the web page within an application window on a user's computing device. For components and elements specified using a URL, the web browser obtains these items as separate data files that are combined into the web page 300 when rendered in the web browser.

When a trusted HTML document 101 is published and edited, a digital envelope 202 is created using the HTML content data of the document. An example of the metadata used in a digital envelope 202 is described in detail in reference to FIG. 4 below. Included within the digital envelope 202 is a hash value generated using a hash function applied to all of the data included within the HTML content data. When a web page 300 utilizes multiple components and elements, a hash value is generated for each component and element. For example, a digital image 306c is a data file in a known format (PNG, JPG, TIFF) that may be processed by the hash function to generate a hash value for the digital image. Under an embodiment, CSS and other formatting data points may also be incorporated into the hash, alongside ‘visual’ elements like images, etc. A separate hash value is generated for the HTML code that defines the web page 300, including any URLs to the components and elements. All of these hash values identify each component and element when a trusted HTML document 101 is published and verified. For HTML items defined using a URL, the corresponding content may be downloaded and processed separately to generate hash values for each item. All of the hash values may be retained in the metadata of the digital envelope 202 or may be combined into a single value in alternate embodiments.

FIG. 4 illustrates components 400 of a digital envelope that is part of a trusted HTML document utilized by a system for utilizing trusted HTML content according to the present invention. The components 400 of a digital envelope 202 are shown including a link to a published document 401, digital certificate data 402, and a calculated and signed hash value 403 from the trusted HTML document 101. The link to a published document 401 provides a URL to the corresponding document on the publishing server 108 to permit the content to be accessed. The digital certificate 402 provides a public encryption key that is used to verify the digital signature on the hash value 403, which contains encrypted data generated by processing the contents of the trusted HTML document 101 through a hash function that is subsequently encrypted (signed) using a private encryption key of the signing party which may be the trusted document server, in the case where the content is merely being published, or could be signed by other digital certificates/keys of other parties, including users 102-105 using their own digital certificates and signing keys.

When the trusted HTML document is validated, the contents of the document downloaded and displayed to a user using the link to a published document 401 are processed using the hash function of the trusted document server 107 to generate a calculated hash value. The hash value 403 from the digital envelope 202 is decrypted using the public encryption key in the digital certificate 402 with the result compared to the calculated hash value. The calculated hash value matches the decrypted hash value when the contents of the trusted HTML document 101 displayed is identical to the HTML document when first published.

When a party adds a signature to the trusted HTML document 101, the document with its signature is processed by the trusted document server 107 to generate a new hash value for retention within a digital envelope 202. When a second signature is added to the trusted document having an added signature, the new hash value is stored in a subsequent nested digital envelope 232, and is generated using the content data for the document with its signature that was previously processed by the trusted document server 107. The content data used to generate a hash value for a nested digital envelope 232 includes all of the content of the document within an inner digital envelope 202, the content of the trusted HTML document 201, and data specifying the edits being added to the content 101. This process for generating nested digital envelopes is repeated with the addition of each subsequent signature.

Each version of the trusted HTML document corresponding to the addition of one or more signatures may be stored on the publishing server 108 for later use. In alternate embodiments, the original published HTML document 101, each added signature, and the subsequent digital envelopes, or nested digital envelopes, may be maintained. In both embodiments, the verification of a document may occur by starting with the published document, generating its initial hash value and its certificate, adding each signature, and creating a digital envelope in the same manner disclosed above.

In a preferred embodiment, the hash value 403 may be generated using a SHA256 hash algorithm. Other hash algorithms of various lengths also may be used to generate hash values sufficiently unique when combined with a digital signature associated with a digital certificate 402 to provide a desired level of assurance that the document is authentic.

Additionally, the above example embodiments present a trusted HTML document that is altered with the addition of one or more signatures from various parties. In additional embodiments, the changes made by each party may include other edits to the content of the document, including additions, deletions, and changes. In this embodiment, the hash value generated by the trusted document server 107 for each version of the document is calculated in a manner similar to the above example. The edits to the content may replace or be in addition to the insertion of a signature and creation of a digital envelope with the remaining processing proceeding as described herein. The edit to the content specifies the content that is changed, including its location within the document relative to other content, and the type of change being made (add, delete, and edit) are saved in place of the signature. Using this data, a version of the document at every stage in the editing process may be recreated by reconstructing the document in the order that the edits were made.

FIG. 5 illustrates an example embodiment 500 of a user identification and verification system for utilizing trusted HTML content according to the present invention. Before a party may edit a document and request the edited version of the documented be processed, a user 102 authenticates 501 the identity of the user to the trusted document server 107, the publishing server 108, and/or a party's processing systems. The authentication of a user may be performed as described herein when it is performed by the trusted document server 107, the publishing server 108, and/or a party's processing systems. When the authentication is performed by a computing device other than the trusted document server 107, an API request submitted to the trusted document server 107 indicates how the user's identity was authenticated and verified. Data describing the user authentication and identity verification is included within an audit trail disclosed in detail in reference to FIG. 17 when used by the trusted document server 107 to generate encrypted hash values and to verify an HTML document to contain HTML content data is identical to the content data when the corresponding trusted HTML document 101 was first published.

Authentication of a user 102 may be performed by the trusted document server 107. The user authenticator 512 is responsible for authenticating a user based upon user input. Typically, the user 102 input uses a username and password. Multi-factor authentication, use of one-time passwords, biometric factors such as retinal scans 511 and fingerprints 512, similar credential analysis mechanisms, and similar secure authentication mechanisms may be included in the user profile. Every time a party is authenticated, the trusted document server 107 recognizes the user type, i.e., document publisher, document editor or user, along with all past activities from account details in the database. Based on user type, the trusted document server 107 behavior will change.

As otherwise disclosed herein, trusted documents 101 obtain and maintain their trusted status by recording all changes made to a version of a trusted document 101 to indicate an author of each change. With this recorded data, an audit of any version of the trusted document 101 may be reviewed and verified 502.

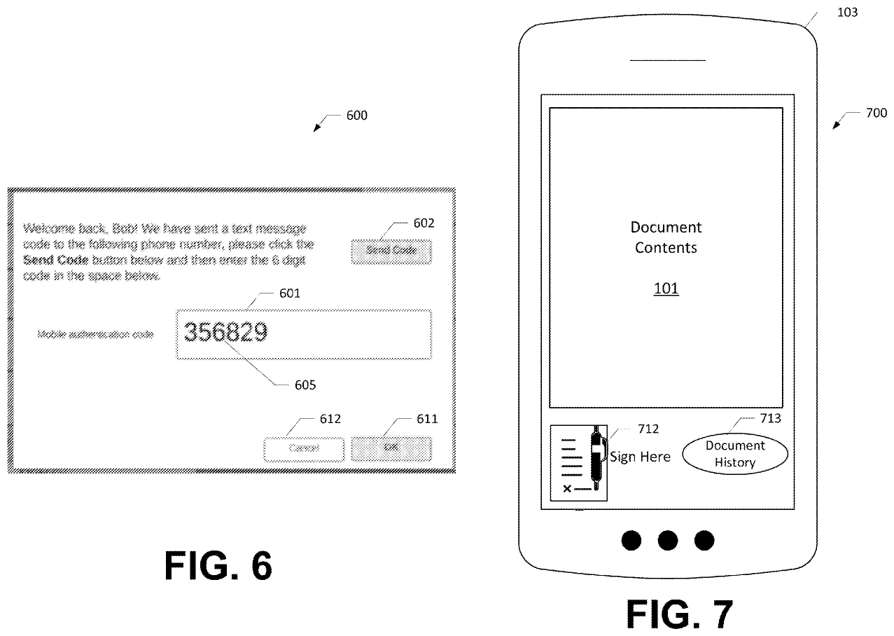

FIG. 6 illustrates an example embodiment 600 multi-factor authentication code window 600 used to verify the identity of an individual within a system for utilizing trusted HTML content according to the present invention. The multi-factor authentication code window 600 may be presented to a user during the authentication process and contains a unique one-time use code input field 601, a send code button 602, an ok button 611, and a cancel button 612. The user may request that a one-time use code 605 be sent to the user by a previously configured communication channel, for example an email to an email account for the user and an SMS message to a mobile phone of the user. The trusted document server 107 obtains the previously configured communication channel from a user account database and transmits the one-time use code 605 over the previously configured communication channel to the user.

The user obtains the one-time use code 605 from a device associated with the previously configured communication channel for entry into the unique one-time use code input field 601. The user uses the ok button 611 to submit the one-time use code 605 to the trusted document server 107 to complete the authentication of the user. If the one-time use code 605 does not match the code that the trusted document server 107 sent to the user, the authentication fails. The one-time use code 605 is valid for a brief amount of time after transmission by the trusted document server 107 and/or the publishing server 108 to ensure that the one-time use code 605 has been obtained by a user with access to the device associated with the previously configured communication channel that was originally configured by the user.

The trusted document server 107 and/or the publishing server 108 maintains a user account data in their respective databases 106a-b for each entity to be authenticated depending upon whether the particular server performs necessary authentication of a user as disclosed herein. An entry in the user account database is created and configured for each entity before an entity may be authenticated. Each entry in the user account database may include identity information for the entity, for example, a name, contact address, email address(es), phone numbers, user ID, password, and user type. The entry also may include biometric data obtained from the user when the entry is configured. The trusted document server 107 may utilize any of these data values to make an authentication determination as required.

The authentication database and the above-described authentication process may be performed by the trusted document server 107 and/or the publishing server 108 as disclosed above. A separate authentication processor (not shown) may be communicatively coupled to the trusted document server 107 in alternate embodiments. The authentication process also may utilize one or more known authentication devices to perform the authentication of the identity of the user. For example, if one of the parties to a contract executed using a trusted document 101 is a financial institution maintaining authentication data and related processes for its customers to access accounts electronically, the authentication of the user of the trusted document 101 when being executed may utilize existing authentication processes in use by the financial institution and its computing systems.

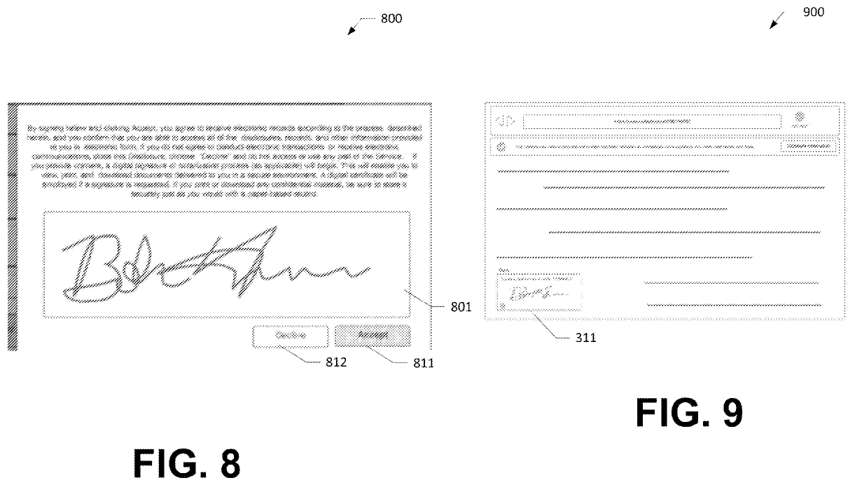

FIG. 7 illustrates an example embodiment 700 of a mobile device 103 presenting a trusted HTML document 101 in a system for utilizing trusted HTML content according to the present invention. The trusted document 101 may present contents in a data field on a display of the mobile device 103. Additional document items including a sign here button 712 and a document history button 713 may also be displayed on the mobile device 103. The document history button 713 may present the user with information associated with the publication of the trusted document 101 including its author and authentication data as well as any subsequent changes made to the trusted document 101 since its publication, identity of the user making the edits, and authentication data associated with the user. The sign here button 712 activates a document signature process as disclosed in reference to FIGS. 8-9 below.

FIG. 8 illustrates an example embodiment 800 of a document signature input window 800 in a system for utilizing trusted HTML content according to the present invention. The trusted HTML document 101 is typically obtained from the publishing server 108 and displayed in a client application or a web browser. The user may verify the trusted HTML document 101 using an API to the trusted document server 107 as described above. In this operation, a user may ensure that the document to be signed corresponds to a published document expected to be retrieved and signed. This verification may be performed on documents that contain one or more signatures added to a published document that includes a digital envelope as disclosed herein.

The document signature input window 800 may include a signature field 801, an accept button 811, and a decline button 812. In one example embodiment, a user enters a signature into the signature field 801 using an input device on the user computing device 102-105, for example the touch screen of a mobile phone 103 and a tablet 104 or the trackpad of a laptop 102. In alternate embodiments, other authentication methods may be used to ensure the party signing a document is a party expected to be signing the document.

Any supported user input device may be used to enter a signature into the signature field 801. The user selects the accept button 811 to accept the signature entered into the signature field 801 into the trusted document 101. FIG. 9 illustrates an example embodiment 900 of a trusted document having an embedded signature used within a system for utilizing trusted HTML content according to the present invention. The user computing device 102-105 transmits the edited trusted document 900 containing the user signature 311 to the trusted document server 107 as disclosed herein for validation of the edit. The embodiments of the document signature input window 800 and the edited trusted document 900 are for exemplary purposes and may utilize alternate forms and formats when the trusted document is created and published.

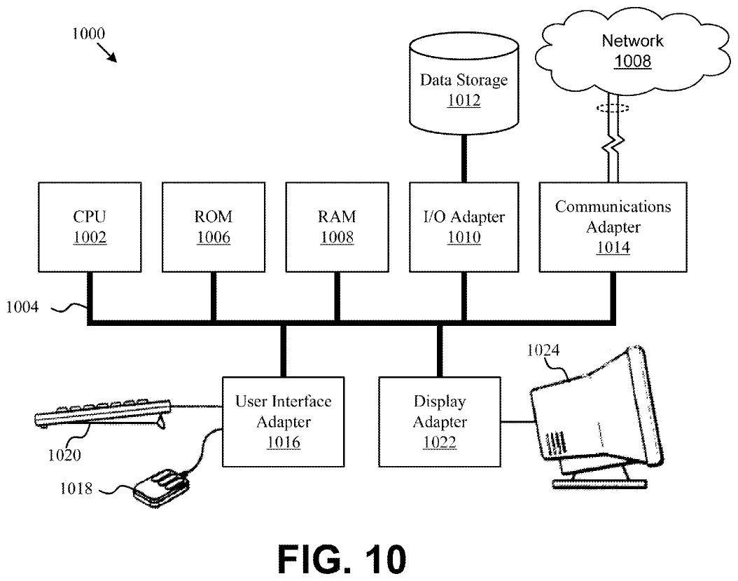

FIG. 10 illustrates a computer system 1000 adapted according to certain embodiments of the server and/or the user interface device. The central processing unit (“CPU”) 1002 is coupled to the system bus 1004. The CPU 1002 may be a general-purpose CPU or microprocessor, graphics processing unit (“GPU”), and/or microcontroller. The present embodiments are not restricted by the architecture of the CPU 1002 so long as the CPU 1002, whether directly or indirectly, supports the operations as described herein. The CPU 1002 may execute the various logical instructions according to the present embodiments.

The computer system 1000 also may include random access memory (RAM) 808, which may be synchronous RAM (SRAM), dynamic RAM (DRAM), synchronous dynamic RAM (SDRAM), or the like. The computer system 1000 may utilize RAM 1008 to store the various data structures used by a software application. The computer system 1000 may also include read only memory (ROM) 1006 which may be PROM, EPROM, EEPROM, optical storage, or the like. The ROM may store configuration information for booting the computer system 1000. The RAM 1008 and the ROM 1006 hold user and system data, and both the RAM 1008 and the ROM 1006 may be randomly accessed.

The computer system 1000 also may include an input/output (I/O) adapter 1010, a communications adapter 1014, a user interface adapter 1016, and a display adapter 1022. The I/O adapter 1010 and/or the user interface adapter 1016 may, in certain embodiments, enable a user to interact with the computer system 1000. In a further embodiment, the display adapter 1022 may display a graphical user interface (GUI) associated with a software or web-based application on a display device 1024, such as a monitor or touch screen.

The I/O adapter 1010 may couple one or more storage devices 1012, such as one or more of a hard drive, a solid-state storage device, a flash drive, a compact disc (CD) drive, a floppy disk drive, and a tape drive, to the computer system 1000. According to one embodiment, the data storage 1012 may be a separate server coupled to the computer system 800 through a network connection to the I/O adapter 1010. The communications adapter 1014 may be adapted to couple the computer system 1000 to the network 110, which may be one or more of a LAN, WAN, and/or the Internet. The communications adapter 1014 may also be adapted to couple the computer system 1000 to other networks such as a global positioning system (GPS) or a Bluetooth network. The user interface adapter 1016 couples user input devices, such as a keyboard 1020, a pointing device 1018, and/or a touch screen (not shown) to the computer system 1000. The keyboard 1020 may be an on-screen keyboard displayed on a touch panel. Additional devices (not shown) such as a camera, microphone, video camera, accelerometer, compass, and or gyroscope may be coupled to the user interface adapter 1016. The display adapter 1022 may be driven by the CPU 1002 to control the display on the display device 1024. Any of the devices 1002-1022 may be physical and/or logical.

The applications of the present disclosure are not limited to the architecture of the computer system 800. Rather the computer system 1000 is provided as an example of one type of computing device that may be adapted to perform the functions of a trusted document server 107, publishing server 108, and/or the user devices 102-105. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, state machine digital logic-based circuitry, or other circuitry.

The embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules. As such, persons of ordinary skill in the art may utilize any number of suitable electronic devices and similar structures capable of executing a sequence of logical operations according to the described embodiments. For example, the computer system 800 may be virtualized for access by multiple users and/or applications.

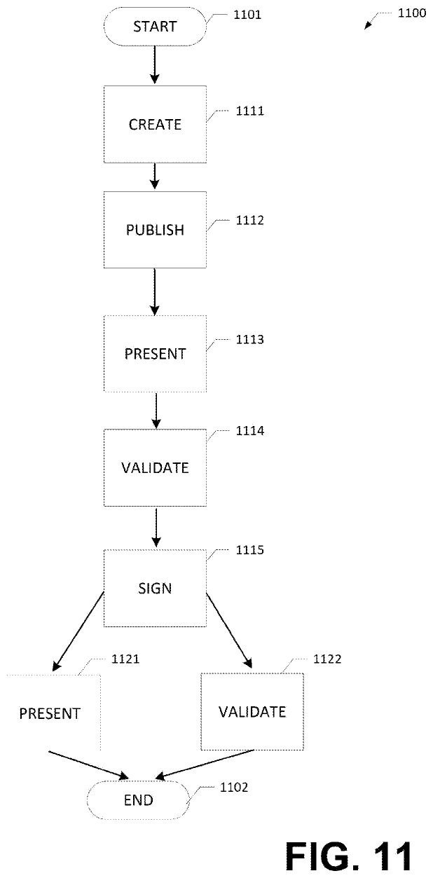

FIG. 11 illustrates a flowchart 1100 corresponding to a method performed by software components of a system for utilizing trusted HTML content according to the present invention. The flowchart of FIG. 11 describes a set of method steps performed by a system to publish and obtain one or more signatures to a trusted HTML document 101. The process 1100 begins at 1101 and proceeds to a creation step 1111 in which an HTML document is created. The created document is published as a trusted HTML document 101 by a publishing server 108 in step 1112 and presented to a signer in step 1113.

The signer may validate the trusted HTML document 101 in step 1114 to confirm that the HTML content received as the trusted HTML document 101 contains the same content as when the document was first published. The signer may add a signature to the trusted HTML document 101 in step 1115 with the resultant document presented to the signer for review in step 1121. The signed document is validated in step 1122 to create a digital envelope containing an updated hash value and the signer certificate for use to verify the signed document as disclosed herein before the process 1100 ends 1102.

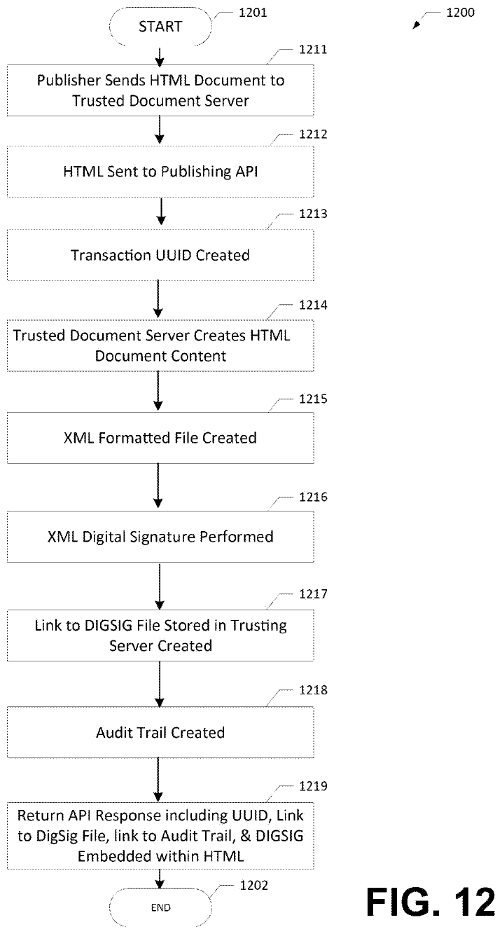

FIG. 12 illustrates another flowchart 1200 corresponding to a method performed by software components of a system for utilizing trusted HTML content according to the present invention. The flowchart of FIG. 12 describes a set of more detailed method steps performed by a system to publish a trusted HTML document 101. The process 1200 begins at 1201 and proceeds to a document publisher sending an HTML document to the trusted document server 107 (step 1211) in which a trusted HTML document is created. The created document is sent to the publishing server 108 using its provided publishing API in step 1212. In step 1213, a transaction UUID is created before the trusted document server 107 creates a hash of the trusted HTML document 101 using the transmitted HTML document in step 1214. In the step 1215, the trusted document server 107 generates an XML formatted file which is then digitally signed by the trusted document server 107 in step 1216. In one embodiment, XMLDigSig is used to format the digital signature content in the HTML content. In alternate embodiments, other formats for a digital signature may be used. The preferred embodiment would use an extant cryptographic standard such as XML DigSig or XadES formats to formalize/memorialize the signature within the HTML content.

In step 1217, a digitally signed trusted HTML document (DIGSIG) file is stored in the trusted document server 107 and a URL link to the DIGSIG file is created. The trusted document server 107 creates an audit trail corresponding to the transaction in step 1218. The process 1200 ends 1202 after the trusted document server 107 returns an API response 1219 that includes the UUID, URL link to the DIGSIG file, and a digital signature that is now embedded in the trusted HTML document 101.

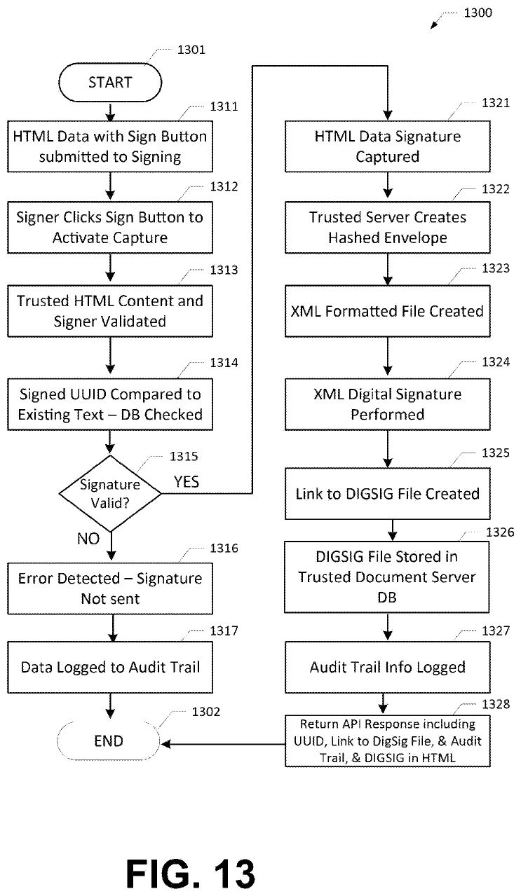

FIG. 13 illustrates yet another flowchart 1300 corresponding to a method performed by software components of a system for adding signatures to trusted HTML content according to the present invention. A content signing process 1300 begins 1301 with trusted HTML content with a sign button being sent to a signer in step 1311. In step 1312, a signer clicks on a sign button 312 to activate capture of a signature. An example of capture of a signature is disclosed in reference to FIGS. 8-9 herein.

Identity of the signer and the captured signature are validated in step 1313 with a signed UUID compared 1314 to a previously published and validated version of the trusted HTML document 101 maintained within the system database 106. Test step 1315 determines whether ID of a signing monitoring user is properly authenticated and verifies that the content of trusted document 102 to be signed contains the correct content contained within the published document 101. Test step 1315 determines whether the trusted document 201 and the captured signature from an identified signer are valid, and if not, an error is detected in step 1316 in which the captured signature is not utilized, the error is logged into an audit trail in step 1317, and the process 1300 ends. A message may be displayed to the signer to indicate the nature of the error.

If test step 1315 determines that the trusted document 201 and the captured signature are valid, the HTML data signature is captured in step 1321. The trusted document server 107 creates a hashed digital envelope in step 1322, an XML formatted file is created in step 1323, and an XML digital signature is performed in step 1324. The digital signature uses the digital certificate of the signer to sign the trusted HTML document 101 with the resulting identifying data stored into the digital envelope.

In step 1325, a URL link is created to the DIGSIG file created and stored when the signature of the signer is captured. The DIGSIG file is stored within the system database of the trusted document server 207 in step 1326. Audit trail data associated with the addition of the signature of the trusted HTML document 101 is logged in step 1328. The trusted document server 107 generates and returns an API response including the UUID, link to DIGSIG file, audit trail, and the DIGSIG in HTML in step 1328 before the process 1300 ends 1302.

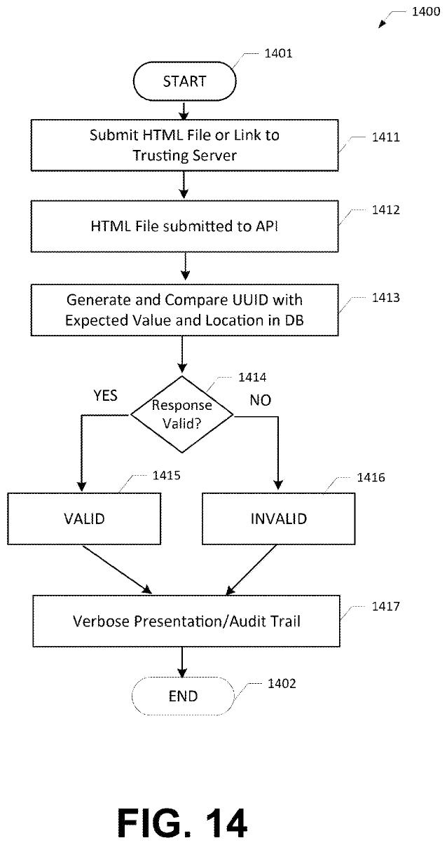

FIG. 14 illustrates an additional flowchart 1400 corresponding to a method performed by software components in a system for verifying trusted HTML content according to the present invention. Process 1400 begins 1401 when previously published trusted HTML content is submitted to the trusted document server 107 in step 1411 for verification. The HTML may be submitted to the trusted document server 107 as a file containing the content or as a URL link to a file containing the HTML content using an API in step 1412. Use of the API call is merely the means to cause the HTML content / data to be ‘read’ by the trusted document server 107. For example. sent via API, processed by a browser extension or browser, and then parsed back via the API, or similar mechanisms.

In step 1413, a UUID for the submitted HTML content UUID is used to find the original, expected content, retrieve the stored, signed hash and compare it to the ‘live’ hash of the content currently being viewed. Test step 1414 determines whether corresponding hash values from the submitted HTML content matches the values retrieved from the trusted document database 106b, and if so, a verification indication of the HTML content is identified as being a valid trusted HTML document in step 1415; otherwise, the verification indication of the HTML content is identified as being an invalid trusted HTML document in step 1416. The verification indication may be returned as a verbose response 1417 to the API call as the process 1400 ends 1402.

FIG. 15 illustrates a certificate of trust for a trusted document publishing request and completion dataset in a system and method for utilizing trusted HTML content according to the present invention. The certificate of trust 1500 includes a publishing request data record 1501 and a trusted document published data record 1502. The publishing request data record 1501 includes a set of data entries 1511 defining the trusted document 201, as described in reference to FIG. 2, to be published as a trusted document by the system and method for utilizing trusted HTML content 100.

Similarly, the trusted document published data record 1502 includes a set of data entries 1521-1523 documenting the trusted document 201 and the related information useful in verifying the authenticity of the trusted document 201. The set of data entries 1521-1523 include a URL to the trusted document 1521 in its published location, a certificate 1522 used in securing the contents of the trusted document, and a digital signature 1523 corresponding to applying the certificate 1522 to the contents of the trusted document 201.

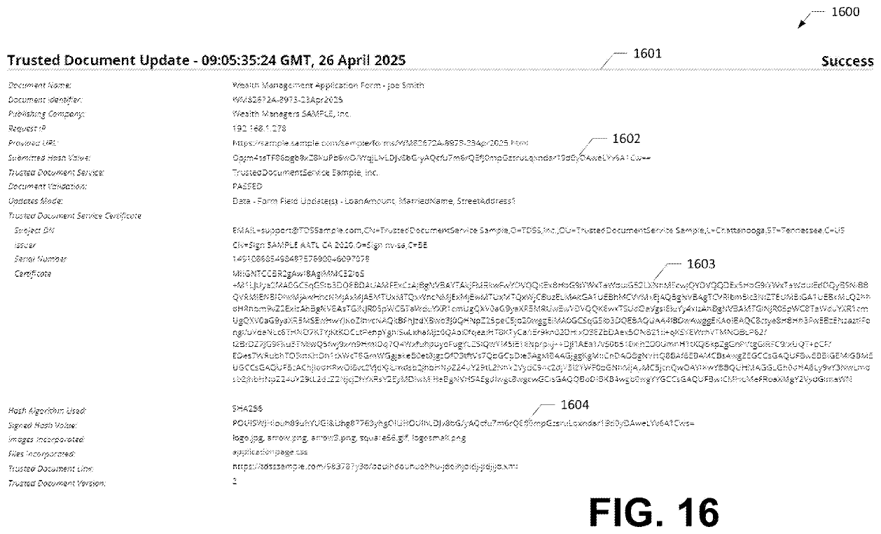

FIG. 16 illustrates an example certificate of trust for a trusted document update in a system and method for utilizing trusted HTML content according to the present invention. The certificate of trust of a transaction 1600 is used to document a successful update made to the trusted document 202. The certificate of trust of a transaction 1600 includes an updated trusted document data record 1601 that documents the update made to the trusted document 202. The updated trusted document data record 1601 includes a set of data entries 1602-1604 that specify URL 1602 to the trusted document 202 in its published location, a certificate 1603 used in securing the contents of the updated trusted document 202, and a digital signature 1604 corresponding to applying the certificate 1603 to the contents of the trusted document 202.

FIG. 17 illustrates an example certificate of trust for the addition of a user's signature in a transaction of a system and method for utilizing trusted HTML content according to the present invention. The certificate of trust 1700 documents the addition of a user's signature and related alteration to the trusted document 202 as described in reference to FIG. 2. The updated trusted document data record 1701 includes a set of data entries 1702-1705 that specify URL 1702 to the trusted document 202 in its published location, identification data 1703 of a user creating the updated trusted document 202, a certificate 1704 used in securing the contents of the updated trusted document 202, and a digital signature 1705 corresponding to applying the certificate 1704 to the contents of the trusted document 202.

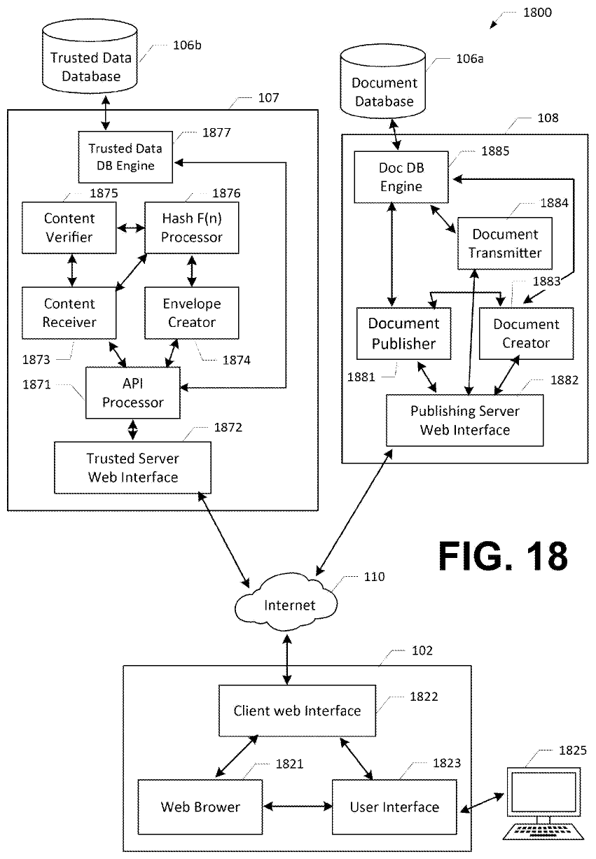

FIG. 18 illustrates a computing system 1800 of software components for a system and method for utilizing trusted HTML content according to the present invention. The system 1800 of software components include the software components of a client/signer processing system 102, the software components of a trusted document server 107, and the software components of a publishing server 108. The client/signer processing system 102, the trusted document server 107, and the publishing server 108 are communicatively coupled to each other over the Internet 110 in a preferred embodiment. These computing systems implement the system and method for utilizing trusted HTML content according to the present invention.

As seen in FIG. 15, the Trusted Document Publishing Request includes Document Name, Document Identifier, Publishing Company, Request IP, Provided URL, Submitted Hash Value, and Trust Document Service. The trusted Document Published includes Document UUID, Document Name, Document Identifier, Provided URL, Trusted Document Service, and Trusted Document Service Certificate (which includes Subject DN, Issuer, Serial Number and Certificate, Hash Algorithm Used, Signed Hash Value, Images Incorporated, Files Incorporated, Trusted Document Link, and Trusted Document Version).

As seen in FIG. 16, the Trusted Document Update includes Document Name, Document Identifier, Publishing Company, Request IP, Provided URL, Submitted Hash Value, Trusted Document Service, Document Validation, Updates Made, and Trusted Document Service Certificate (which includes Subject DN, Issuer, Serial Number and Certificate, Hash Algorithm Used, Signed Hash Value, Images Incorporated, Files Incorporated, Trusted Document Link, and Trusted Document Version).

As seen in FIG. 17, the Trusted Document Update includes Document Name, Document Identifier, Publishing Company, Request IP, Provided URL, Submitted Hash Value, Trusted Document Service, Document Validation, Updates Made, Signer Info (which includes Name, Email, IP Address UserAgent, Authentication Method, and Signature Image), and Trusted Document Service Certificate (which includes Subject DN, Issuer, Serial Number and Certificate, Hash Algorithm Used, Signed Hash Value, Images Incorporated, Files Incorporated, Trusted Document Link, and Trusted Document Version).

The client/signer processing system 102 utilizes a set of software components that includes a web browser component 1821, a client web interface 1822, and a user interface component 1823.

The web browser component 1821 accepts HTML data from remote computing systems over the Internet 110 that is rendered for display upon the input/output devices 1825. The web browser component 1821 accepts input commands from users via the user interface component 1823 that activate hyperlinks and complete data used to communicate with remote processing systems such as the trusted document server 107 and the publishing server 108. The web browser components 1821 may be implemented as a part of client application, as part of web browser extension components added to standard third-party applications, and as part of executable code included in the data is downloaded along with the HTML content.

The client web interface 1822 permits the client computing device 102 to communicate with remote computing devices 107-108 and the Internet 110. The client web interface 1822 performs all of the data formatting, computer to computer communications, encryption processing, and all similar operations needed by the web server to communicate with users.

The user interface component 1823 is coupled to user input/output devices 1825 to provide users with a mechanism to receive and review data of the web browser 1821 and provide input data to the user computing device 102.

The trusted document server 107 utilizes a set of software components that include an API processor 1871, a trusted server web interface 1872, a content receiver-transmitter component 1873, a digital envelope creator 1874, a content verifier 1875, a hash function processor 1876, and a trusted document database engine 1877.

The API processor 1871 receives data from remote computing systems specifying a submission to an API service request associated with publishing HTML content as a trusted HTML document and associated with verifying a trusted HTML document corresponding to a previously published document with any additions of digital signatures. The API processor 1871 communicates with the components within the trusted document server 107 to generate a response to the API request as disclosed herein.

The trusted server web interface 1872 permits the web server 101 to communicate with remote server computing devices such as the publishing server 108 and mobile devices 102. The trusted server web interface 1872 performs all of the data formatting, computer to computer communications, encryption processing, and all similar operations needed by the web server to communicate with users.

The digital envelope creator 1874 accepts HTML content data from remote processing systems that are part of an API request and maintains a copy of the HTML content during the generation of a response to the API request. The content receiver-transmitter component 1873 also transmits trusted HTML data and/or digital envelope data as part of an API response to remote processing systems.

The digital envelope creator 1874 generates a digital envelope containing a link to a document, a digital certificate, and an encrypted hash value as disclosed herein in reference to FIG. 4-9. The digital envelope creator 1874 communicates with the API processor 1871 and the hash function processor 1876 to utilize HTML data received as part of an API request to generate the encrypted hash value as disclosed herein.

The content verifier 1875 processes trusted HTML content data and an associated digital envelope to calculate an encrypted hash value for the HTML content received as part of an API request to compare the result to a previously generated encrypted hash value when a document is published and/or when a digital signature is otherwise inserted into a published HTML document.

The hash function processor 1876 generates the encrypted hash value from the trusted HTML document and a digital certificate associated with a source of the trusted HTML document using a specified hash function. The generated encrypted hash value is returned as part of a digital envelope associated with the trusted HTML document when a signature is added. The generated encrypted hash value is also utilized as part of a verification of a document determined by the content verifier 1875.

The trusted document database engine 1877 processes all database operations for the document storage in the trusted document server 107. These operations include insertion of trusted HTML documents into the trusted document database 106b, deletion of trusted HTML documents from the trusted document database 106b, searching and retrieving trusted HTML documents from the trusted document database 106b, and indexing the trusted document database 106b to maintain efficient searching when needed. The trusted document database 106b may be organized as any organized database for storing, searching, and retrieving documents as otherwise recited to be included in the present invention in the attached claims.

The publishing server 108 utilizes a set of software components that include a document publisher 1881, a publishing server web interface 1882, a document creator 1883, a document transmitter-receiver 1884, and a document database engine 1885.

The document publisher 1881 receives HTML content for publishing by a source user when submitted to the publishing server 108 to create a trusted HTML document 101 via the trusted document server 107. The document publisher 1881 uses the components 1882-1885 of the publishing server 108 when publishing the trusted HTML document 101.

The publishing server web interface 1882 permits the publishing server 108 to communicate with remote user computing devices 102 and the trusted document server 107. The publishing server web interface 1882 performs all of the data formatting, computer to computer communications, encryption processing, and all similar operations needed by the web server to communicate with monitoring users.

The document creator 1883 accepts input commands and data to create HTML content data to be included in a trusted HTML document 101. As disclosed above, the publishing server 108 may be hosted as part of a party's web presence in which the party is generating content data to be used in documents as well as submitted from other remote computing systems. The document creator 1883 performs the operations to allow the content to be defined, retrieved from a local data source, and included into the HTML content data within a trusted HTML document.

The document transmitter-receiver 1884 transmits HTML content data and trusted HTML documents 101 to one or more client processing systems 102 and the trusted document server 107 upon request. The document transmitter-receiver 1884 may retrieve a previously published trusted HTML document 101 from the database 106 as needed for transmission to the remote computing systems for use and verification of the content as disclosed herein. The document transmitter-receiver 1884 also may receive HTML content data from a source, including remote processing system and the document creator 1883 to publish the corresponding trusted HTML document 101.

The document database engine 1885 processes all database operations for the document storage in the publishing server 108. These operations include insertion of trusted HTML documents into the document database 106a, deletion of trusted HTML documents from the document database 106a, searching and retrieving trusted HTML documents from the document database 106, and indexing the document database 106a to maintain efficient searching when needed. The document database 106a may be organized as any organized database for storing, searching, and retrieving documents as otherwise recited to be included in the present invention in the attached claims.

Trusted document content may also be stored using blockchain technology, under an embodiment. A blockchain is a distributed ledger with growing lists of records (blocks) that are securely linked together via cryptographic hashes. Each block contains a cryptographic hash of the previous block, a timestamp, and transaction data (generally represented as a Merkle tree, where data nodes are represented by leaves). Since each block contains information about the previous block, they effectively form a chain with each additional block linking to the ones before it. Consequently, blockchain transactions are irreversible in that, once they are recorded, the data in any given block cannot be altered retroactively without altering all subsequent blocks.

Blockchains are typically managed by a peer-to-peer (P2P) computer network for use as a public distributed ledger, where nodes collectively adhere to a consensus algorithm protocol to add and validate new transaction blocks.

A method is described herein comprising one or more applications running on at least one server, the one or more applications configured to generate a digital envelope for use in validating web content, wherein the generating the digital envelope comprises generating a first hash value by applying a first hash function to the web content and digitally signing the hash value using a private key, wherein the digitally signing includes generating a public key for decrypting the digital signature, wherein the digital envelope includes a link to the web content, the public key, and the digital signature, receive an update to the web content, generate an additional digital envelope for use in validating the updated web content, wherein the generating the additional digital envelope comprises generating an additional hash value by applying the first hash function to the updated web content and digitally signing the additional hash value using an additional private key, wherein the digitally signing includes generating an additional public key for decrypting the additional digital signature, wherein the additional digital envelope includes a link to the updated web content, the additional public key, and the additional digital signature, embedding the digital envelope within the additional digital envelope, and iteratively generating digital envelopes for each subsequent update, wherein each subsequent digital envelope embeds the prior digital envelope.

Under an embodiment, the method stores each digital envelope to generate an audit trail.

In embodiments, the digital signature comprises public private key encryption.

In embodiments, the validating comprises using a digital envelope to authenticate contents of respective web content.

In embodiments, the validating comprises accessing the respective web content using the link provided by the digital envelope.

In embodiments, the validating comprises hashing the respective web content using the first hash function.

In embodiments, the validating comprises decrypting the respective digital signature using the corresponding public key.

In embodiments, the validating comprises authenticating the respective web content when the decrypted digital signature matches the hashed web content.

In embodiments, the web content comprises HTML content.

In embodiments, the web content comprises an enforceable contract.

In embodiments, the web content comprises a digital representation of a user signature.

A method is described herein comprising under an embodiment one or more applications running on at least one server, the one or more applications configured to receive iterations of web content, wherein the iterations include original web content and subsequent updates to the web content, generate for each iteration a digital envelope for use in validating the web content, wherein the generating the digital envelope comprises generating a first hash value by applying a first hash function to the web content and digitally signing the hash value using a private key, wherein the digitally signing includes generating a public key for decrypting the digital signature, wherein the digital envelope includes a link to the web content, the public key, and the digital signature, embedding the digital envelope for each iteration within the digital envelope of the subsequent iteration.

The method of an embodiment stores each digital envelope to generate an audit trail.

In embodiments, the digital signature comprises public private key encryption.

In embodiments, the validating comprises using a digital envelope to authenticate contents of respective web content.

In embodiments, the validating comprises accessing the respective web content using the link provided by the digital envelope.

In embodiments, the validating comprises hashing the respective web content using the first hash function.

In embodiments, the validating comprises decrypting the respective digital signature using the corresponding public key.

In embodiments, the validating comprises authenticating the respective web content when the decrypted digital signature matches the hashed web content.

In embodiments, the web content comprises HTML content.

In embodiments, the web content comprises an enforceable contract.

In embodiments, the web content comprises a digital representation of a user signature.

A system is described herein comprising under an embodiment a platform running platform software on at least one server, the platform software communicatively coupled with an application running on a processor of a remote device, wherein at least one of the platform software and the application is configured to generate a digital envelope for use in validating web content, wherein the generating the digital envelope comprises generating a first hash value by applying a first hash function to the web content and digitally signing the hash value using a private key, wherein the digitally signing includes generating a public key for decrypting the digital signature, wherein the digital envelope includes a link to the web content, the public key, and the digital signature, update the web content, wherein the updating comprises receiving and validating the web content using the digital envelope, receive the update to the web content, wherein the receiving comprises authenticating a creator of the update, generate an additional digital envelope for use in validating the updated web content, wherein the generating the additional digital envelope comprises generating an additional hash value by applying the first hash function to the updated web content and digitally signing the additional hash value using an additional private key, wherein the digitally signing includes generating an additional public key for decrypting the additional digital signature, wherein the additional digital envelope includes a link to the updated web content, the additional public key, and the additional digital signature, and embedding the digital envelope within the additional digital envelope.

The system of an embodiment stores each digital envelope to generate an audit trail.

In embodiments, the digital signature comprises public private key encryption.

In embodiments, the receiving and validating comprises using a digital envelope to authenticate contents of respective web content.

In embodiments, the receiving and validating comprises accessing the respective web content using the link provided by the digital envelope.

In embodiments, the receiving and validating comprises hashing the respective web content using the first hash function.

In embodiments, the receiving and validating comprises decrypting the respective digital signature using the corresponding public key.

In embodiments, the receiving and validating comprises authenticating the respective web content when the decrypted digital signature matches the hashed web content.

In embodiments, the web content comprises HTML content.

In embodiments, the web content comprises an enforceable contract.

In embodiments, the web content comprises digital acceptance of the enforceable contract.

A system and method for utilizing trusted HTML content can be a component of a single system, multiple systems, and/or geographically separate systems. The system and method for utilizing trusted HTML content can also be a subcomponent or subsystem of a single system, multiple systems, and/or geographically separate systems. The components of system and method for utilizing trusted HTML content can be coupled to one or more other components (not shown) of a host system or a system coupled to the host system.

One or more components of the system and method for utilizing trusted HTML content and/or a corresponding interface, system or application to which the system and method for utilizing trusted HTML content is coupled or connected includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

The components of any system that includes system and method for utilizing trusted HTML content can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the system and method for utilizing trusted HTML content and corresponding systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, Systems on a Chip (SOCs) as well as application specific integrated circuits (ASICs). Some other possibilities for implementing aspects of the system and method for utilizing trusted HTML content and corresponding systems and methods include: microcontrollers with memory (such as electronically erasable programmable read only memory (EEPROM)), embedded microprocessors, firmware, software, etc. Furthermore, aspects of the system and method for utilizing trusted HTML content and corresponding systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the system and method for utilizing trusted HTML content is not intended to be exhaustive or to limit the systems and methods to the precise forms disclosed. While specific embodiments of, and examples for, the system and method for utilizing trusted HTML content and corresponding systems and methods are described herein for illustrative purposes, various equivalent modifications are possible within the scope of the systems and methods, as those skilled in the relevant art will recognize. The teachings of the system and method for utilizing trusted HTML content and corresponding systems and methods provided herein can be applied to other systems and methods, not only for the systems and methods described above.

The elements and acts of the various embodiments described above can be combined to provide further embodiments. These and other changes can be made to the system and method for utilizing trusted HTML content and corresponding systems and methods in light of the above detailed description.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. A method comprising, one or more applications running on at least one server, the one or more applications configured to:
generate a digital envelope for use in validating web content, wherein the generating the digital envelope comprises generating a first hash value by applying a first hash function to the web content and digitally signing the hash value using a private key, wherein the digitally signing includes generating a public key for decrypting the digital signature, wherein the digital envelope includes a link to the web content, the public key, and the digital signature;
receive an update to the web content;
generate an additional digital envelope for use in validating the updated web content, wherein the generating the additional digital envelope comprises generating an additional hash value by applying the first hash function to the updated web content and digitally signing the additional hash value using an additional private key, wherein the digitally signing includes generating an additional public key for decrypting the additional digital signature, wherein the additional digital envelope includes a link to the updated web content, the additional public key, and the additional digital signature;
embedding the digital envelope within the additional digital envelope;
iteratively generating digital envelopes for each subsequent update, wherein each subsequent digital envelope embeds the prior digital envelope.

2. The method of claim 1, storing each digital envelope to generate an audit trail.

3. The method of claim 1, wherein the digital signature comprises public private key encryption.

4. The method of claim 1, wherein the validating comprises using a digital envelope to authenticate contents of respective web content.

5. The method of claim 4, wherein the validating comprises accessing the respective web content using the link provided by the digital envelope.

6. The method of claim 5, wherein the validating comprises hashing the respective web content using the first hash function.

7. The method of claim 6, wherein the validating comprises decrypting the respective digital signature using the corresponding public key.

8. The method of claim 7, wherein the validating comprises authenticating the respective web content when the decrypted digital signature matches the hashed web content.

9. The method of claim 1, wherein the web content comprises HTML content.

10. The method of claim 1, wherein the web content comprises an enforceable contract.

11. The method of claim 1, wherein the web content comprises a digital representation of a user signature.

12. A method comprising, one or more applications running on at least one server, the one or more applications configured to:
receive iterations of web content, wherein the iterations include original web content and subsequent updates to the web content;
generate for each iteration a digital envelope for use in validating the web content, wherein the generating the digital envelope comprises generating a first hash value by applying a first hash function to the web content and digitally signing the hash value using a private key, wherein the digitally signing includes generating a public key for decrypting the digital signature, wherein the digital envelope includes a link to the web content, the public key, and the digital signature;
embedding the digital envelope for each iteration within the digital envelope of the subsequent iteration.

13. The method of claim 12, storing each digital envelope to generate an audit trail.

14. The system of claim 12, wherein the digital signature comprises public private key encryption.

15. The system of claim 12, wherein the validating comprises using a digital envelope to authenticate contents of respective web content.

16. The system of claim 15, wherein the validating comprises accessing the respective web content using the link provided by the digital envelope.

17. The system of claim 16, wherein the validating comprises hashing the respective web content using the first hash function.

18. The system of claim 17, wherein the validating comprises decrypting the respective digital signature using the corresponding public key.

19. The system of claim 18, wherein the validating comprises authenticating the respective web content when the decrypted digital signature matches the hashed web content.

20. The system of claim 12, wherein the web content comprises HTML content.

21. The system of claim 12, wherein the web content comprises an enforceable contract.

22. The system of claim 12, wherein the web content comprises a digital representation of a user signature.

23. A system comprising,
a platform running platform software on at least one server, the platform software communicatively coupled with an application running on a processor of a remote device, wherein at least one of the platform software and the application is configured to:
generate a digital envelope for use in validating web content, wherein the generating the digital envelope comprises generating a first hash value by applying a first hash function to the web content and digitally signing the hash value using a private key, wherein the digitally signing includes generating a public key for decrypting the digital signature, wherein the digital envelope includes a link to the web content, the public key, and the digital signature;
update the web content, wherein the updating comprises receiving and validating the web content using the digital envelope;
receive the update to the web content, wherein the receiving comprises authenticating a creator of the update;
generate an additional digital envelope for use in validating the updated web content, wherein the generating the additional digital envelope comprises generating an additional hash value by applying the first hash function to the updated web content and digitally signing the additional hash value using an additional private key, wherein the digitally signing includes generating an additional public key for decrypting the additional digital signature, wherein the additional digital envelope includes a link to the updated web content, the additional public key, and the additional digital signature;
embedding the digital envelope within the additional digital envelope.

24. The system of claim 23, storing each digital envelope to generate an audit trail.

25. The system of claim 23, wherein the digital signature comprises public private key encryption.

26. The system of claim 23, wherein the receiving and validating comprises using a digital envelope to authenticate contents of respective web content.

27. The system of claim 26, wherein the receiving and validating comprises accessing the respective web content using the link provided by the digital envelope.

28. The system of claim 27, wherein the receiving and validating comprises hashing the respective web content using the first hash function.

29. The system of claim 28, wherein the receiving and validating comprises decrypting the respective digital signature using the corresponding public key.

30. The system of claim 29, wherein the receiving and validating comprises authenticating the respective web content when the decrypted digital signature matches the hashed web content.

31. The system of claim 23, wherein the web content comprises HTML content.

32. The system of claim 23, wherein the web content comprises an enforceable contract.

33. The system of claim 32, wherein the web content comprises digital acceptance of the enforceable contract.
